(19) United States
(12) Patent Application Publication
(10) Pub. No.: US 2008/0048840 A1
(43) Pub. Date: Feb. 28, 2008

(54) Delayed start-up verbal warning unit

(76) Inventors: Donnie L. Reagan, Big Spring, TX (US); Jerry Paul Green, Del Rio, TX (US); George C. Clinton, Big Spring, TX (US)

Correspondence Address: LITMAN LAW OFFICES, LTD., P.O. BOX 15035, CRYSTAL CITY STATION, ARLINGTON, VA, 22215, US

(21) Appl. No.: 11/892,308

(22) Filed: Aug. 21, 2007

Related U.S. Application Data
(60) Provisional application No. 60/839,130, filed on Aug. 22, 2006.

(51) Int. Cl. G08B 3/00

(52) U.S. Cl. 340/309.7

(57) ABSTRACT

The delayed start-up verbal warning unit includes an audible alarm that comprises a verbal warning and instructions. The unit is connected to a control circuit for machinery, e.g., an oil well pumping unit. The control circuit includes a means of generating a start-up signal for the machinery. Where the machinery is an oil well pumping unit, the unit operates to issue a verbal warning and instructions related to imminent start-up of the pumping unit. Playback of the verbal warning delays propagation of the start-up signal to the pump, thereby providing people in the area the opportunity to avoid injury by evacuating the area. Additionally, start-up signal status may be sent by the unit to a Supervisory Control And Data Acquisition (SCADA) system for further processing and analysis.

### CROSS-REFERENCE TO RELATED APPLICATION

This application claims the benefit of U.S. Provisional Patent Application Ser. No. 60/839,130, filed Aug. 22, 2006.

### BACKGROUND OF THE INVENTION

1. Field of the Invention

The present invention relates to a safety device that can be combined with existing machinery controls, e.g., for an oil well pumping unit in order to provide audible verbal warning and corrective action instructions to people in the area of the pump that the pump is about to start operating. The device may be connected to existing control system components and can delay machinery start-up until the audible verbal warning is through playing.

2. Description of the Related Art

A large majority of the oil well pumping units in the U.S. operate on a time delay basis controlled by a time clock that will start and stop the oil well pumping unit at given time intervals. This intermittent operation increases the amount of oil pumped by allowing the well to recover pressure, but also causes a dangerous safety hazard. When the oil well pumping unit is in a dormant state, often people stand on or around the pumping unit, unaware that the pumping unit will restart at any moment, resulting in people being injured and even killed. Automatic start units have warning signs and sometimes fences in place, but these are not enough. It would be desirable to provide an aural, verbal warning and instructions capable of delaying imminent start-up of machinery in operable communication with the device. Under such circumstances, a loud warning message may be initiated to alert nearby people and tell them what action to take to remove themselves from a dangerous environment surrounding start up of a machine.

Thus a delayed start-up verbal warning unit solving the aforementioned problems is desired.

### SUMMARY OF THE INVENTION

The delayed start-up verbal warning unit includes an audible alarm that comprises a verbal warning and instructions. The unit is connected to a control circuit for machinery, e.g., an oil well pumping unit. The control circuit includes a means of generating a start-up signal for the machinery. Where the machinery is an oil well pumping unit, the unit operates to issue a verbal warning and instructions related to imminent start-up of the pump. Playback of the verbal warning delays propagation of the start-up signal to the pump, thereby providing people in the area the opportunity to avoid injury by evacuating the area. Additionally, start-up signal status may be sent by the unit to a Supervisory Control And Data Acquisition (SCADA) system for further processing and analysis.

These and other features of the present invention will become readily apparent upon further review of the following specification and drawings.

### BRIEF DESCRIPTION OF THE DRAWINGS

FIG. 1 is an environmental, diagrammatic view of the delayed start-up verbal warning unit, according to the present invention.

FIG. 2 is a block diagram of the delayed start-up verbal warning unit, according to the present invention.

FIG. 3 is a side view of an oil well pumping unit that can be controlled by the delayed start-up verbal warning unit, according to the present invention.

Similar reference characters denote corresponding features consistently throughout the attached drawings.

### DETAILED DESCRIPTION OF THE PREFERRED EMBODIMENT

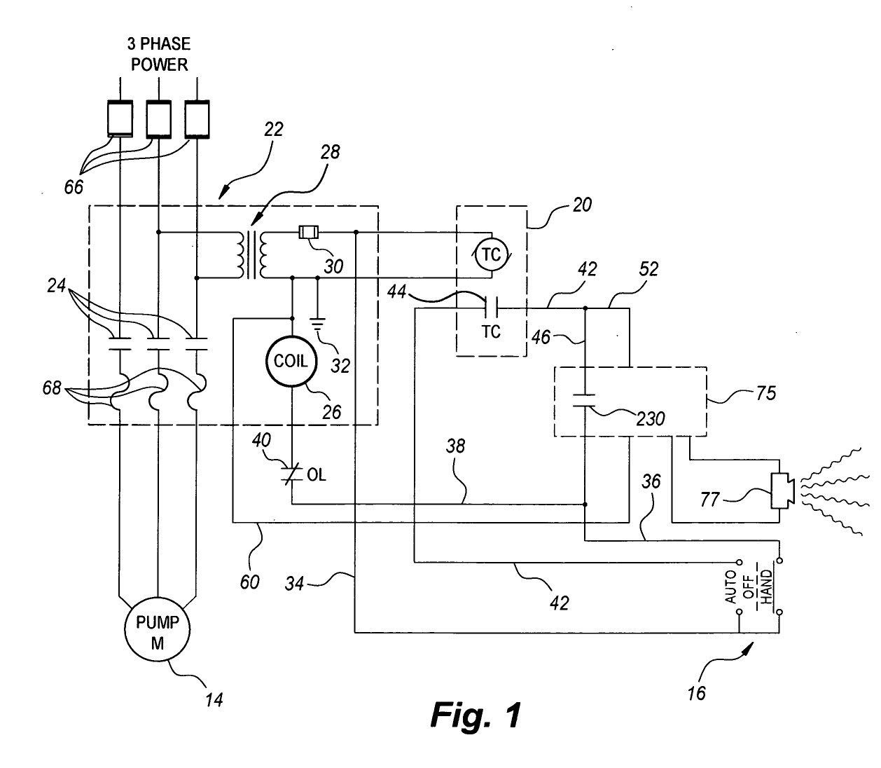

As shown in FIGS. 1-3, the present invention is a delayed start-up verbal warning unit 75 having an audible alarm that comprises a verbal warning and instructions. The unit 75 is connected to a control circuit for machinery, e.g., an oil well pumping unit 10. The control circuit includes a means of generating a start-up signal for the machinery. Where the machinery is an oil pump, such as pump unit 10, the device 75 operates to issue a verbal warning and instructions related to imminent start-up of the pump 10.

Playback of the verbal warning delays propagation of the start-up signal to the pump 10, thereby providing people in the area the opportunity to avoid injury by evacuating the area. Additionally, start-up signal status may be sent by the device 75 to a Supervisory Control And Data Acquisition (SCADA) system or other Data Acquisition System for further processing and analysis. Moreover, the start-up signal status may be routed to a supplementary alarm system.

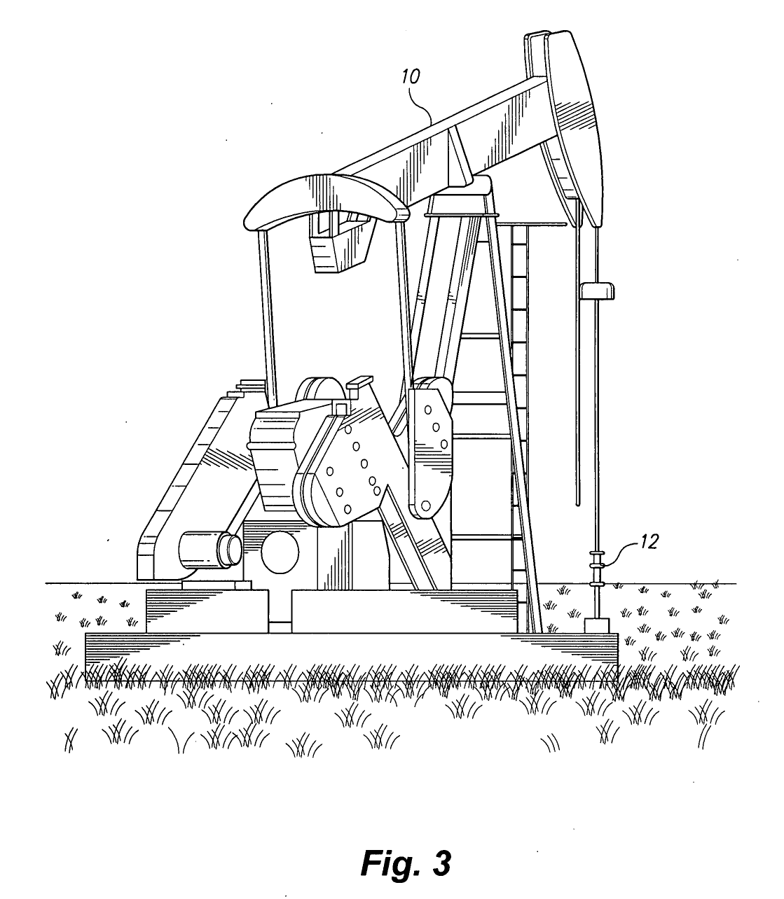

As most clearly shown in FIG. 3, a conventional oil well pumping unit 10 pumps oil from a well 12. As shown in FIG. 1, pumping unit 10 is driven by a three-phase motor 14 normally in intermittent ON-OFF fashion under the control of a three-position switch 16. Three-phase power 66 can supply power required by pumping unit 10. The intermittent operation is necessary to allow the well 12 to recover pressure after each pumping operation. The three-position switch 16 may be located in a control panel or other access point near pumping unit 10. From the OFF position, switch 16 can be moved to a “manual” or “hand” position or to an “automatic” position, as indicated in FIG. 1.

Conventionally, pumps, such as pumping unit 10, that are used to extract oil from the ground are normally unmanned and automatically operated by a time clock, such as. the time clock 20 illustrated in FIG. 1. Three-phase power is provided to run pumping motor 14. Motor 14 is started, run, and stopped by a conventional motor starter 22, using time clock 20 to close main contacts 24 in main power lines 25 through coil 26 to enable motor 14 to run. For safety and to provide the convenience of using a conventional time clock such as time clock 20, control circuit power is generally derived from a step-down transformer 28 within motor starter 22. The step-down transformer 28 steps down the motor voltage, which may range from 200 V to 480 V nominal, to 120 V.

To conform to National Electric Code requirements, one side of transformer 28 is shown fused at 30 and the other side is shown grounded at 32. Time clock 20 is connected to run at all times. The hot (fused) side of the transformer output feeds ON-OFF-AUTO three-position selector switch 16 through line 34. In the “Hand” position shown in FIG. 3, the current continues through lines 36 and 38 and normally-closed contacts 40 to energize coil 26, which closes contacts 24, allowing the three-phase power to energize motor 14. The manual circuit bypasses time clock 20, which is not needed because the operator is on the scene at pumping unit 10. However, it should be understood that the device 75 may be configured to provide a delayed start warning while switch 16 is in the “HAND” position as well.

Coil 26 is conventionally located in motor starter 22. In the prior art, when switch 16 is set to the “automatic” position, power flows through line 34, through switch 16, through line 42, through contacts 44 the opening and closing of which is controlled by time clock 20, through lines 46 and 38 and normally-closed contacts 40 to coil 26 to close the contacts 24 and operate motor 14 for a period of time controlled by time clock 20. Normally-open contacts 230 are present in line 46 to obviate safety problems during automatic operation of unmanned pumping units such as pumping unit 10. Since an unmanned pumping unit may be located in or near inhabited areas, it may become an attractive nuisance to passersby, particularly children.

The unexpected start-up of the pumping unit sets into motion much of the large structure of the pumping mechanism. Therefore, children playing on the pumping unit, and even experienced service personnel who may have forgotten to disable the pumping unit, may be injured or even killed upon start-up.

The present invention provides an audible warning that includes verbal warning messages and verbal instructions related to imminent start-up so that those who are sufficiently close to the pumping units can evacuate the area prior to the occurrence of a dangerous condition, i.e., pump start-up. The preferably multilingual, verbal audible unit 75 is provided to delay start-up. After the message and instructions have ended, pump operation, which had been inhibited by the message playback of the warning system 75, is then permitted. The warning system 75 may be configured to operate in combination with, e.g., pump off controllers, cycle timing controllers, or any other type of machinery controller.

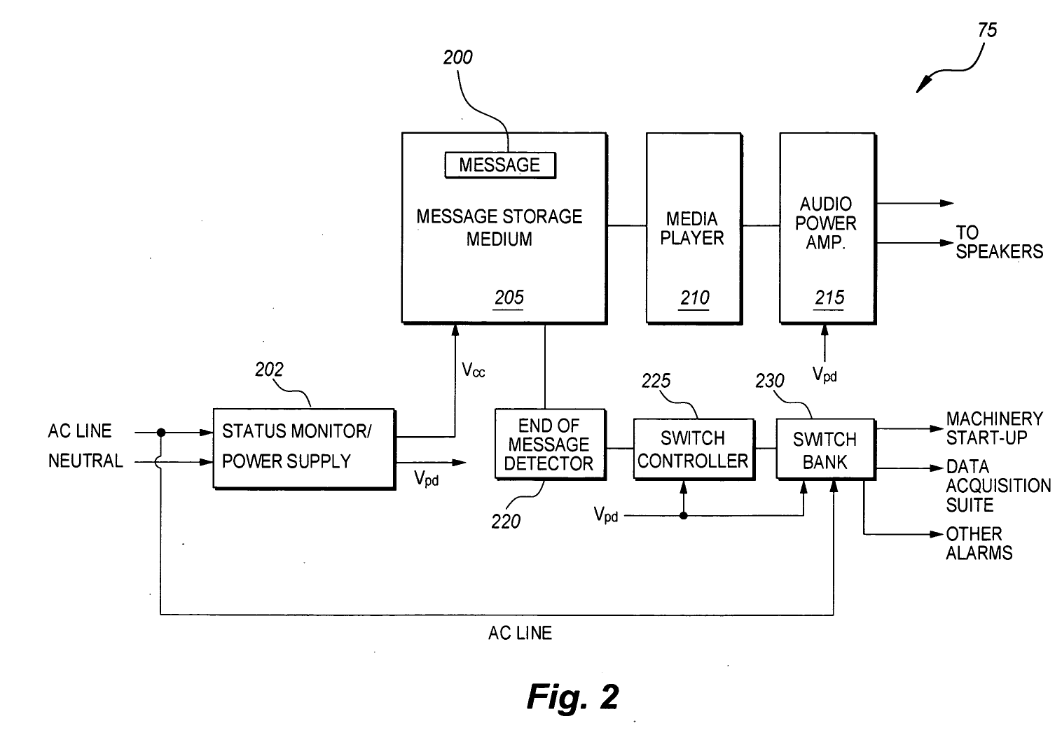

In the embodiment shown in FIG. 1, when switch 16 is put in the “automatic” position, current flows through line 34, switch 16, and line 42 to normally-open contacts 44. As shown in FIGS. 1 and 2, after a suitable period of time determined by time clock 20, contacts 44 close, allowing current to continue traveling along line 42 to line 46, where it is blocked by normally-open switch bank contacts 230. Current simultaneously flows to line 52 to start the operation of delayed start-up verbal warning unit 75. As shown in FIG. 2, AC line startup voltage (voltage at line 52 in FIG. 1) is routed to machine startup monitor/switching power supply 202, as well as to switch input at switch bank 230. Additionally, the warning system 75 may have a connection to grounded line 60 (as shown in FIG. 1).

The warning system 75 is configured to play a warning message as soon as start-up voltage is detected by startup monitor/switching power supply 202. Upon detection of the startup voltage, the startup monitor/switching power supply 202 supplies voltages V_{cc} and V_{Pd} to logic devices and current driving devices, respectively, to the warning system unit 75. It should be understood that while the embodiment shown detects an AC startup voltage, according to the present invention, startup status monitor 202 can be configured to detect any type of signal, e.g., DC, pulse, a modulated signal, and the like.

The switch at switch bank 230, which routes the AC line startup voltage to the pump starter 26, is normally open, and can not close until a control signal is received from switch controller 225. In turn, switch controller 225 does not direct the AC line startup switch at switch bank 230 to close until an end of message has been detected by end of message detector 220.

The warning system 75 has message storage medium 205. The message storage medium 205 may be any type of non volatile digital memory such as, e.g., NVRAM, EPROM, EEPROM, and the like. Optionally, message storage medium 205 may be any type of substantially non volatile analog memory such as, e.g., magnetic tape.

A recorded message 200 comprising verbal warnings and verbal corrective action instructions is stored in message storage medium 205. An exemplary message 200 may comprise the warning: “WARNING—THE PUMPING UNIT IS IN STARTING MODE—DANGER—CLEAR THE AREA IMMEDIATELY”]“—10-9-8-7-6—WARNING PUMPING UNIT STARTING—DANGER—5-4-3-2-1”, and may be recorded in a plurality of languages, although a single language recording is also contemplated by the present invention. The message 200 can be factory installed into the message storage medium 205 by any number of methods known in the art. Optionally, the warning system 75 may have a recording interface through which the message 200 can be recorded onto the storage medium 205.

A media player 210 can play the message 200 stored in storage medium 205. Depending on the nature of the storage medium 205, i.e., whether the storage medium 205 is analog, or digital, media player 210 may correspondingly be analog, e.g., tape playback machine, or digital, e.g., Digital to Analog (D/A) converter. Audio from the media player 210 is routed to power amplifier 215 and then on to loud speakers 77 or a bull horn (not shown). The end of message detector 220 is operably connected to the message storage medium 205. If the message 200 is stored digitally, the end of message detector 220 can check during message playback by the media player 210 whether an end of file has been reached. An end of file signals the end of messaging and the media player 210 stops playback. Additionally, the end of message detector 220 can notify the switch controller 225 that the message has ended.

Responsively, the switch controller 225 closes the AC line switch in the switch bank 230 thus energizing coil 26 to cause the machinery, i.e., oil well pumping unit 10, to start. In an alternative analog embodiment, the end of message detector 220 may be a playback carrier sensing device that can sense the end of a recorded message on, e.g., magnetic tape and then notify the switch controller 225.

With respect to the environment in which the present invention can operate, as shown in FIG. 1, thermal overload protective elements 68 are disposed directly below contacts 24.

It is to be understood that the present invention is not limited to the embodiment described above, but encompasses any and all embodiments within the scope of the following claims.

We claim:

1. A delayed start-up verbal warning unit, comprising:
a motor control circuit adapted for starting and running motor-controlled machinery;
an audio transducer;
a warning message circuit for playing a warning message stored therein on the audio transducer; and
a switching circuit connected to the motor control circuit and to the warning message circuit for applying power to switch the motor control circuit on and for applying power to switch the warning message circuit for playing back the warning message, the switching circuit being configured for delaying switching the motor control circuit on until after playing of the warning message has been completed.

2. The delayed start-up verbal warning unit according to claim 1, wherein the warning message comprises a message signaling imminent startup of an oil pumping unit.

3. The delayed start-up verbal warning unit according to claim 1, wherein said warning message circuit has a message storage medium for storing the warning message.

4. The delayed start-up verbal warning unit according to claim 1, wherein said audio transducer comprises a media player for playing the warning message.

5. The delayed start-up verbal warning unit according to claim 1, wherein said warning message comprises a verbal warning.

6. The delayed start-up verbal warning unit according to claim 1, wherein said switching circuit comprises an end of message detector.

7. The delayed start-up verbal warning unit according to claim 1, wherein said warning message circuit has a storage medium having non-volatile digital memory for storing the warning message.

8. The delayed start-up verbal warning unit according to claim 1, wherein the warning message is multilingual.

9. The delayed start-up verbal warning unit according to claim 1, wherein said warning message circuit comprises a digital media player, said switching circuit comprising an end of message detector for detecting an end of file indicator of a digital media file having the warning message stored thereon.

10. A delayed start-up verbal warning unit, comprising:
a message storage medium containing a verbal warning related to an imminent start-up of machinery;
a media player for playing the verbal warning;
an audio amplifier for amplifying the verbal warning sufficient for playing on a loudspeaker;
an end of message detector having an end of message signal that signals the end of playback of the verbal warning;
a startup status monitor for detecting a machinery startup voltage and outputting a status signal responsive thereto;
a switch controller, the switch controller outputting a switch control signal responsive to the status signal in combination with the end of message signal; and
a switch bank connected to the switch controller, the switch bank being responsive to the switch control signal from the switch controller to control startup of the machinery after the message has played.

11. The delayed start-up verbal warning unit according to claim 10, wherein the verbal warning content comprises a message signaling imminent startup of an oil pumping unit.

12. The delayed start-up verbal warning unit according to claim 10, wherein the verbal warning content is in more than one language.

13. The delayed start-up verbal warning unit according to claim 10, wherein the storage medium comprises non-volatile digital memory.

14. The delayed start-up verbal warning unit according to claim 10, further comprising a recording interface through which the verbal warning can be recorded onto the storage medium.

16. The delayed start-up verbal warning unit according to claim 10, wherein the media player is digital and capable of reading a file containing the warning stored in the message storage medium.

17. The delayed start-up verbal warning unit according to claim 10, wherein the end of message detector is a playback carrier sensing device that can sense the end of the recorded warning message and then notify the switch controller of the end of message.
